(19) United States
(12) Patent Application Publication
(10) Pub. No.: US 2013/0230292 A1
(43) Pub. Date: Sep. 5, 2013

(54) Apparatus, Method and Computer-Readable Storage Medium for Media Processing and Delivery

(71) Applicant: CARE CAM INNOVATIONS, LLC, West Conshohocken, PA (US)

(72) Inventors: D. Shannon Pierce, Greenville, SC (US); Todd Scott, Greer, SC (US); James Cooper, Simpsonville, SC (US); James R. Phifer, Landrum, SC (US)

(73) Assignee: CARE CAM INNOVATIONS, LLC, West Conshohacken, PA (US)

(21) Appl. No.: 13/782,531

(22) Filed: Mar. 1, 2013

Related U.S. Application Data
(60) Provisional application No. 61/606,092, filed on Mar. 2, 2012.

(51) Int. Cl. H04N 9/79

(52) U.S. Cl. CPC H04N 9/79
USPC 386/200; 386/241

(57) ABSTRACT

An apparatus is provided that includes a processor and a memory storing executable instructions that in response to execution by the processor cause the apparatus to at least perform a number of operations. The apparatus of this aspect may be caused to communicate content between a server and media recorder or viewer. The server may include a controller that is part of a messaging layer of a multi-channel interface engine having at least a first channel and a second channel each of which functions as a first-in-first-out pipeline. The communication may include the apparatus being caused to communicate system information and media content below a threshold size over the first channel. And the apparatus may be caused to push media content above the threshold size for communication over the second channel.

### CROSS-REFERENCE TO RELATED APPLICATION(S)

The present application claims priority to U.S. Provisional Patent Application No. 61/606,092, entitled: Apparatus, Method and Computer-Readable Storage Medium for Media Processing and Delivery, filed on Mar. 2, 2012, the content of which is incorporated herein by reference in its entirety.

### TECHNOLOGICAL FIELD

The present disclosure relates generally to processing and delivery of media and, in particular, to fragmenting media for more efficient searching and delivery, and load-balancing delivery of media over a network such as the Internet.

### BACKGROUND

Medical care includes doctors, nurses and other healthcare providers documenting patient care through use of handwritten notes, forms, narratives, electronic data entry, etc. Such documents may require a considerable amount of time to produce.

Alternately, healthcare providers may dictate observations, instructions, and procedures either contemporaneously while examining or otherwise treating the patient, or, thereafter. These dictated observations must then be transcribed in some manner into usable written reports, computer files, or other documentation formats. Such reports may be for the patient's use, the writer's use, referral information, treatment histories, archival and/or regulatory purposes.

Accordingly, it would be desirable to have a system which eliminates, or greatly reduces, the amount of data entry and paper-based documentation in favor of electronic documentation, and also to provide improved access to such documentation once created. It would be further desirable for such a system to improve the manner by which such electronic documentation may be processed and/or delivered.

### BRIEF SUMMARY

According to one aspect of example implementations of the present disclosure, an apparatus is provided that includes a processor and a memory storing executable instructions that in response to execution by the processor cause the apparatus to at least perform a number of operations. The apparatus of this aspect may be caused to communicate content between a server and media recorder or viewer. The server may include a controller that is part of a messaging layer of a multi-channel interface engine (e.g., an HL7 interface engine) having at least a first channel and a second channel each of which functions as a first-in-first-out pipeline. The communication may include the apparatus being caused to communicate system information and media content below a threshold size over the first channel. And the apparatus may be caused to push media content above the threshold size for communication over the second channel.

In one example, the multi-channel interface engine may further have at least a third channel. In this example, the apparatus may be caused to push media content above the threshold size for communication over one or more of the second or third channels according to a multi-channel load-balance management mechanism for load balancing on the second and third channels.

According to another aspect of example implementations of the present disclosure, an apparatus is provided that similarly includes a processor and a memory storing executable instructions. The apparatus of this other aspect may be caused to record media content by a media recorder, and segment the media content into a plurality of sequential fragments. The media content may be related to care being provided to a patient by a healthcare provider, and during the recording, the apparatus may be caused to receive selection of categories consistent with the care being provided, and tag the media content with the selected categories. The apparatus may be caused to segment the media content along the categories each of which may include one or more fragments. Each fragment may have associated metadata with information identifying the media recorder, patient, healthcare provider, category and an order of the fragment relative to other fragments. And each fragment may be independently searchable and playable, and may be playable in one contiguous sequence with one or more other fragments.

In one example, the information identifying the order of the fragment relative to other fragments may include a time at which the fragment begins, and/or a fragment number and total number of fragments.

In one example, the apparatus may be caused to receive selection of categories and tag the media content during continuous recordation of the media content.

In one example, the apparatus being caused to receive selection of categories may include being caused to receive voice input, and perform voice recognition on the voice input to identify the selection of categories.

In other aspects of example implementations, methods and computer-readable storage mediums are provided for media processing and delivery. The features, functions and advantages discussed herein may be achieved independently in various example implementations or may be combined in yet other example implementations further details of which may be seen with reference to the following description and drawings.

### BRIEF DESCRIPTION OF THE DRAWING(S)

Having thus described the technological field of the present disclosure in general terms, reference will now be made to the accompanying drawings, which are not necessarily drawn to scale, and wherein:

FIG. 1 is an illustration of a system in accordance with an example implementation;

FIG. 2 is an illustration of an apparatus that may be configured to operate or otherwise function as one or more components of the system of FIG. 1;

FIG. 3 illustrates one example of a suitable architecture including components of the system of FIG. 1;

FIGS. 4-7 are example views that may be presented by a viewer to search for and present one or more fragments of media content, in accordance with one example implementation;

FIGS. 8-12 illustrate other example implementations of the present disclosure; and

FIGS. 13a, 13b and 13c present additional information according to example implementations of the present disclosure.

### DETAILED DESCRIPTION

Some implementations of the present disclosure will now be described more fully hereinafter with reference to the accompanying drawings, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art.

Unless otherwise specified, the terms “data,” “content,” “information,” and similar terms may be used interchangeably, according to some example implementations of the present disclosure, to refer to data capable of being transmitted, received, operated on, and/or stored. The term “network” may refer to a group of interconnected computers or other computing devices. Within a network, these computers or other computing devices may be interconnected directly or indirectly by various means including via one or more switches, routers, gateways, access points or the like.

Further, as described herein, various messages or other communication may be transmitted or otherwise sent from one component or apparatus to another component or apparatus, and various messages/communication may be received by one component or apparatus from another component or apparatus. It should be understood that transmitting a message/communication may include not only transmission of the message/communication, and receiving a message/communication may include not only receipt of the message/communication. That is, transmitting a message/communication may also include preparation of the message/communication for transmission, or otherwise causing transmission of the message/communication, by a transmitting apparatus or various means of the transmitting apparatus. Similarly, receiving a message/communication may also include causing receipt of the message/communication, by a receiving apparatus or various means of the receiving apparatus.

FIG. 1 depicts a system according to various example implementations of the present disclosure. The system of exemplary implementations of the present disclosure may be primarily described in conjunction with a medical documentation system in which the system of example implementations may be implemented or otherwise in communication. One example of a suitable medical documentation system is disclosed by U.S. Pat. No. 7,555,437 to Pierce, the content of which is incorporated by reference in its entirety. It should be understood, however, that the method and apparatus of implementations of the present disclosure can be utilized in conjunction with a variety of other systems in a variety of other contexts, both in the medical industry and outside of the medical industry.

As shown, the system of one example implementation includes one or more apparatuses configured to function as one or more media recorders 100, one or more servers 102 and one or more viewers 104, which may be configured to communicate with one another as well as one or more external systems or databases 106, either directly or across one or more networks 108. According to example implementations, separate apparatuses may support respective ones of the media recorder, server and viewer. It should be understood, however, that a single apparatus may support more than one of the foregoing, logically separated but co-located within the apparatus. For example, a single apparatus may support a logically separate, but co-located media recorder and viewer. In another example, a single apparatus may support a logically separate, but co-located server and external system/database.

The network(s) 108 may include one or more wide area networks (WANs) such as the Internet, and may include one or more additional wireline and/or wireless networks configured to interwork with the WAN, such as directly or via one or more core network backbones. Examples of suitable wireline networks include area networks such as personal area networks (PANs), local area networks (LANs), campus area networks (CANs), metropolitan area networks (MANs) or the like. Examples of suitable wireless networks include radio access networks, wireless LANs (WLANs), wireless PANs (WPANs) or the like. Generally, a radio access network may refer to any 2nd Generation (2G), 3rd Generation (3G), 4th Generation (4G) or higher generation mobile communication network and their different versions, radio frequency (RF) or any of a number of different wireless networks, as well as to any other wireless radio access network that may be arranged to interwork with such networks.

As suggested above, according to example implementations of the present disclosure, the system and its components including the media recorder 100, server 102, viewer 104 and external system/database 106 may be implemented by various means. Means for implementing the system and its components may include hardware, alone or under direction of one or more computer program code instructions, program instructions or executable computer-readable program code instructions from a computer-readable storage medium.

In one example, one or more apparatuses may be provided that are configured to function as or otherwise implement the system and its components such as those shown and described herein. In examples involving more than one apparatus, the respective apparatuses may be connected to or otherwise in communication with one another in a number of different manners, such as directly or indirectly via one or More networks 108, such as explained above.

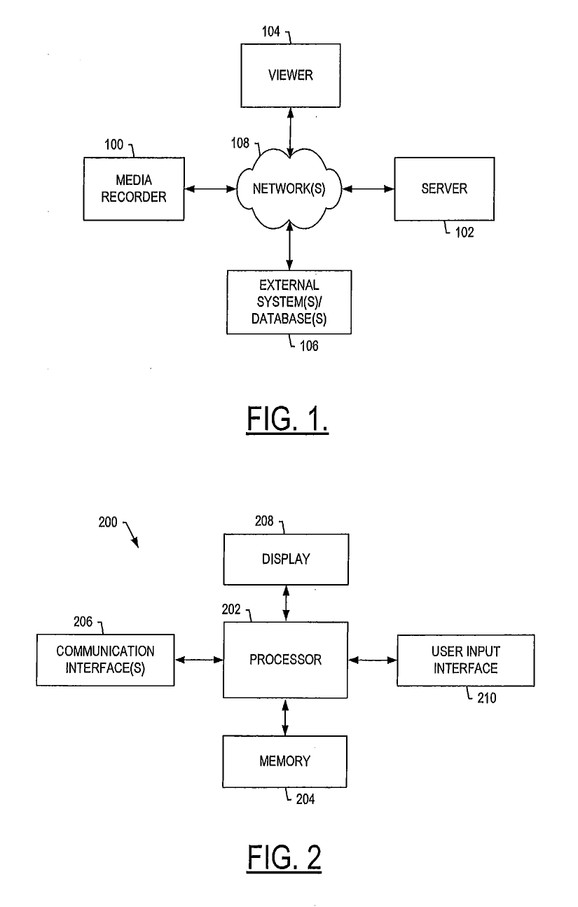

Reference is now made to FIG. 2, which illustrates an apparatus 200 that may be configured to operate or otherwise function as one or more of a media recorder 100, server 102, viewer 104 or external system/database 106 according to example implementations of the present disclosure. Generally, the apparatus may comprise, include or be embodied in one or more stationary or portable electronic devices. Examples of suitable electronic devices include a smartphone, tablet computer, laptop computer, desktop computer, workstation computer, server computer or the like. The apparatus may include one or more of each of a number of components such as, for example, a processor 202 connected to a memory 204.

The processor 202 is generally any piece of hardware that is capable of processing information such as, for example, data, computer-readable program code, instructions or the like (generally “computer programs,” e.g., software, firmware, etc.), and/or other suitable electronic information. More particularly, for example, the processor may be configured to execute computer programs, which may be stored onboard the processor or otherwise stored in the memory 204 (of the same or another apparatus). The processor may be a number of processors, a multi-processor core or some other type of processor, depending on the particular implementation. Further, the processor may be implemented using a number of heterogeneous processor systems in which a main processor is present with one or more secondary processors on a single chip. As another illustrative example, the processor may be a symmetric multi-processor system containing multiple processors of the same type. In yet another example, the processor may be embodied as or otherwise include one or more application-specific integrated circuits (ASICs), field-programmable gate arrays (FPGAs) or the like. Thus, although the processor may be capable of executing a computer program to perform one or more functions, the processor of various examples may be capable of performing one or more functions without the aid of a computer program.

The memory 204 is generally any piece of hardware that is capable of storing information such as, for example, data, computer programs and/or other suitable information either on a temporary basis and/or a permanent basis. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape, a solid-state drive or some combination of the above. Optical disks may include compact disk-read only memory (CD-ROM), compact disk-read/write (CD-R/W), DVD, Blu-ray disk or the like. In various instances, the memory may be referred to as a computer-readable storage medium which, as a non-transitory device capable of storing information, may be distinguishable from computer-readable transmission media such as electronic transitory signals capable of carrying information from one location to another. Computer-readable medium as described herein may generally refer to a computer-readable storage medium or computer-readable transmission medium.

In addition to the memory 204, the processor 202 may also be connected to one or more interfaces for displaying, transmitting and/or receiving information. The interfaces may include a communications interface 206 and/or one or more user interfaces. The communications interface may be configured to transmit and/or receive information, such as to and/or from other apparatus(es), network(s) or the like. The communications interface may be configured to transmit and/or receive information by physical (wireline) and/or wireless communications links. Examples of suitable communication interfaces include a network interface controller (NEC), wireless NIC (WNIC) or the like.

The user interface(s) may include one or more user output interfaces such as a display 208, speaker or the like; and additionally or alternatively, the user interface(s) may include one or more user input interfaces 210. The display may be configured to present or otherwise display information to a user, suitable examples of which include a liquid crystal display (LCD), light-emitting diode display (LED), plasma display panel (PDP) or the like. The user input interfaces may be wireline or wireless, and may be configured to receive information from a user into the apparatus, such as for processing, storage and/or display. Suitable examples of user input interfaces include a microphone, image or video capture device (e.g., digital video recorder), keyboard or keypad, joystick, touch-sensitive surface (separate from or integrated into a touchscreen), biometric sensor or the like. The user interfaces may further include one or more interfaces for communicating with peripherals such as printers, scanners, card readers or the like.

Although not separately shown, in one example, the apparatus 200 may further include a positioning system module or receiver by which the geographic position of the apparatus may be determined or tracked. Examples of a suitable positioning system module include those configured to operate according to Global Positioning System (GPS) modules, Assisted GPS (A-GPS) or the like.

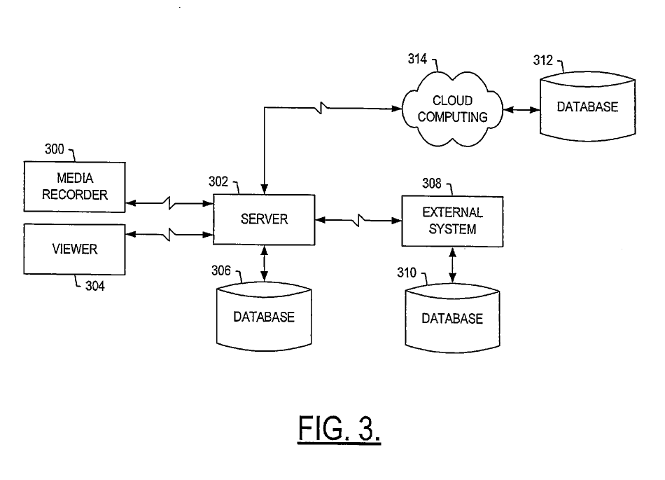

As will be appreciated, the components of the system of FIG. 1 may be configured in any of a number of different architectures to perform any of a number of functions, such as to record, manage and view media and related information. FIG. 3 illustrates one example of a suitable architecture including one or more media recorders 300, one or more servers 302 and one or more viewers 304, and which may be configured to communicate with one another as well as one or more external systems or databases, either directly or across one or more networks (not shown in FIG. 3).

The media recorder 300, server 302 and viewer 304 of FIG. 3 may be examples of respective ones of the media recorder 100, server 102 and viewer 104 of FIG. 1; and as shown, the server may include or otherwise be in communication with a respective database 306. In addition to being configured to communicate with one another, the aforementioned components of FIG. 3 may also be configured to communicate with one or more external systems or databases, such as an external system 308 including or otherwise in communication with a respective database 310, and/or an external database 312 accessible via a cloud computing environment 314. As shown, the external system and external database may be examples of the external system/database 106 shown in FIG. 1.

The media recorder 300 may be stationary or mobile, and may be generally configured to perform one or more functions of a camera, camera unit or documentation device such as that disclosed by the aforementioned '437 patent. The media recorder may be generally configured to receive, record or otherwise capture (generally “record”) video and/or audio (generally “media content”), as well as information related to the media content.

According to one example in the context of a medical documentation system, at least the media recorder 300 may be located in or otherwise carried into an area or room of a healthcare treatment facility or home, such as a hospital room, doctor's office, patient's home, transport vehicle or the like. In various instances, one or more functions of the media recorder may be access restricted to appropriate users (sometimes referred to as operators) such as a healthcare provider, patient and/or patient's designee. In one example, the media recorder may be operated or otherwise configured to record video of care provided to patient, which may include video of a patient and/or health care provider. Additionally or alternatively, for example, the media recorder may be operated or otherwise configured to record audio in the vicinity of the patient and/or health care provider. Suitable audio may be digitally recorded by the media recorder, and may include the voice of patient, healthcare providers and/or bystanders who may be nearby.

The media content may have any of a number of different types of related information. Examples of suitable related information include the date and/or time of the media content's recordation, the identities (e.g., names, identification numbers, etc.) of one or more of the healthcare provider, patient, media recorder operator or the like. Other suitable information may include, for example, treatment codes, diagnosis codes, patient information, vital signs, medications or the like. In various instances, the information may include task/procedure categories, subcategories, sub-subcategories or the like involving treatment of the patient during recordation of the media content. It should be understood that one or more categories may or may not have multiple subcategories, one or more of which may have multiple sub-subcategories, and so forth. Thus, unless otherwise stated, reference to a category or categorization may be equally applicable to and may include a subcategory, sub-subcategory or the like.

In one example, a nurse may perform a “P-A-I-N-T-E-R” analysis of a patient, “PAINTER” being an acronym for categories including Problem (or Plan), Assessment, Intervention, Notifications, Teaching, Evaluation and Records, which are steps followed in examining, treating and caring for a patient. Similarly, patient treatment may involve steps represented by another acronym, “A-D-P-I-E,” for: assess, diagnose, plan, intervene and evaluate. One or more categories may in turn have suitable subcategories, one or more of which may include suitable sub-subcategories, and so forth. For example, the Problem category may have subcategories including H/P (History and Physical), Chief Complaint, Diagnosis, Plan of Care/Visit Details, Patient Goals, Ordered Medications, Ordered Treatment/Labs and/or Discharge Summary. In one example, one or more categories, subcategories, sub-subcategories or the like may have corresponding codes which may more particularly be related to the media content.

The media recorder 300 may receive information related to media content in a number of different manners. For example, information may be received via a suitable user input interface (e.g., microphone, keyboard, touch-sensitive surface, etc.). In one example, the media recorder may have voice recognition capability such that the operator may speak information related to media content as the media content is recorded. In this example, the media recorder may be configured to receive voice input, perform voice recognition to identify appropriate information, and relate the information to the media content as that content is being recorded.

Additionally or alternatively, for example, information may be read from peripheral devices in communication with the media recorder 300. And in another example, information may be received from appropriate medical measurement devices in communication with the media recorder or the like. Examples of suitable devices include stationary or portable vital sign devices, such as blood pressure machines, temperature reading devices, respiratory devices, blood oxygen level devices, EKG devices and the like. In one example, the media recorder may be configured to categorize the related information such as in a manner similar to the media content (e.g., categories, subcategories, sub-subcategories, etc.), and portions of the related information may have further related information such as the same or similar information to that related to the media content (e.g., type of objective numerical data, condition or measurement taken such as vital sign measurements, EKG measurements or blood oxygen levels, the type of device or health care provider taking the measurement, the date and time the measurement was taken, etc.).

Regardless of the particular media content and related information, the media recorder 300 may be configured to locally store the media content and related information, and/or upload or otherwise transfer it to the server 302, such as to the server's translation layer. In one example, the media recorder may be configured to encrypt or otherwise apply a security algorithm (e.g., WEP) to the media content and related information as it is stored and/or transferred to the server. The server may be configured to store the media content and related information in a local database 306. Additionally or alternatively, for example, the server may be configured to upload or otherwise transfer the media content and related information to an external system 308 for storage in its local database 310, or to an external database 312 accessible via the cloud computing environment 314.

In one example, as or after the server 302 receives the media content and related information, the server may receive or otherwise generate further information related to the media content, which may be stored as part of the related information in the local database 306 or transferred to an external system 308 (database 310) or external database 312. This further information may include, for example, a textual transcription or other textual description of the media content. In one example, the textual transcription/description may be requested and received from an external enterprise in communication with the server, and which may receive the media content from the server in order to generate the related textual transcription/description.

The viewer 304 may be configured to communicate with the server to search or otherwise request media content and related information stored by the server's local database 306, or by an external system 308 (database 310) or database 312. In response to the request, the server may be configured to retrieve the requested media content and related information and serve it to the viewer, which in turn, may be configured to display or otherwise present the media content and related information to a user or operator of the viewer.

In accordance with example implementations of the present disclosure, the media recorder 300 may be capable of leveraging together multiple technologies by segmenting media content into much smaller fragments, such as on the order of approximately 100 kilobytes per fragment. Through the use of detailed metadata and addressing of such fragments, upon being stored by the server 302, they may be individually accessed and streamed to a variety of different viewers 304 without requiring as large of a data pipeline. The metadata of a fragment may include at least a portion of the information related to the media content. For example, the metadata may include an identifier of the media recorder such as its Media Access Control (MAC) address, the time (e.g., coordinated universal time—UTC) at which the fragment begins (and possibly the date), the time (and possibly date), patient identifier, health care provider identifier, PAINTER category, media status, media type, media identifier, media fragment number, total fragments in the media content including the fragment, and the like.

In one example, instead of using a raw media content format, the media recorder may segment and store on a binary level easily-consumable fragments in a compressed (or uncompressed, if desired) format. Each small fragment may be individually considered and treated, with its own meta-element data and address. This may allow each fragment to be quickly delivered to a variety of viewers 304 without buffering or requiring a large data pipeline.

In one example in the context of the medical documentation system, a health care provider performing “PAINTER” analysis of a patient may operate the media recorder 300 to record video and/or audio of care provided the patient. During this analysis, the health care provider may tag or otherwise select an event of the analysis such as “Intervention” to cause the media recorder to appropriately categorize (including, if appropriate, subcategorize, sub-subcategorize, etc.) the fragments of media content being recorded, until a next event is tagged/selected (e.g., “Notifications”). At this point, the media recorder may be caused to accordingly change the category of subsequently recorded fragments of media content, which may run continuous with the prior “Intervention” video content. As information related to the recorded media content, categorization of fragments may be accomplished in a number of different manners. In one example, the media recorder may have voice recognition capability such that the health care provider may speak categories for video content as he or she talks through the analysis. In this example, the media recorder may be configured to receive voice input, perform voice recognition to identify appropriate categories of video content, and produce tags to relate the categories to appropriate fragments of the video content.

Using email as an analogy, each of the fragments may stand alone as an individual event, and additionally, such event may include a single image, or thumbnail, associated with a fragment (which in one example may be on the order of 100 kilobytes), and in one example may comprise between a sixty to seventy frame video. The thumbnail itself may only be 10-20 kilobytes. As contrasted to email where individual “packets” are likely to be unintelligible, through use of its algorithms and metadata association, the system of example implementations permits the rebuilding of originally-captured video in proper fragment sequence in the event of a corruption during data transfer, in other words, before “the container” or file holding the video is closed.

In one example, only a small data pipeline is needed to transfer media content, such as a data rate of only approximately 50-100 kilobytes per second. This may permit implementing the media recorder 300 and/or viewer 304 by a mobile device via a mobile phone data service. As a comparison, a typical Internet speed used by many users is on the order of 10-20 megabytes per second.

In one example, the media content may be kept in its native form, which, in one example implementation, is a format that is compressed as recorded. However, the media content may be recorded uncompressed, and in that case, the media content may simply be segmented into more fragments.

Because of the smaller data throughput required by example implementations, the media feed may go straight to mobile devices without having to be browser-based. The media recorder 300 may be configured to encode or transcode (based on post-comparison) the media content to one or more mobile device formats, or other device formats, for optimal delivery to appropriate viewers 304. In one example, the media recorder may be configured to encode the fragments of media content and/or related information through use of a base-64 encoding scheme.

To further illustrate the fragmentation and transfer aspect, consider an example of a video segmented into four fragments, each of which is categorized “A.700” for Assessment/Vital Signs. In one example, these four fragments may be transferred in the following four messages from the media recorder 300 to the server 302. In the example, the messages include respective fragments (represented by “xxxxxxxxx” for convenience) and a number of related metadata.
header=content&ican_id=100e2bf7cd96&tag_date=1/19/2012&tag_time=17:46:44.313&patient_id=1238954367&clinician_id=135790&painter_category=A.700&media_status=&media_date=1/192012&media_time=17:47:10.756&media_type=video&media_id=v1327013208967.mp4&media_fragment_number=1&total_fragments=4&barcode=&text_data=&checksum=349526&route=&dosage=&binary_data=xxxxxxxx
header=content&ican_id=100e2bf7cd96&tag_date=1/19/2012&tag_time=17:46:44.313&patient_id=1238954367&clinician_id=135790&painter_category=A.700&media_status=&media_date=1/19/2012&media_time=17:47:10.756&media_type=video&media_id=v1327013208967.mp4&media_fragment_number=2&total_fragments=4&barcode=&text_data=&checksum=349526&route=&dosage=&binary_data=xxxxxxxx
header=content&ican_id=100e2bf7cd96&tag_date=1/19/2012&tag_time=17:46:44.313&patient_id=1238954367&clinician_id=135790&painter_category=A.700&media_status=&media_date=1/19/2012&media_time=17:47:10.756&media_type=video&media_id=v1327013208967.mp4&media_fragment_number=3&total_fragments=4&barcode=&text_data=&checksum=349526&route=&dosage=&binary_data=xxxxxxxx
header=content&ican_id=100e2bf7cd96&tag_date=1/19/2012&tag_time=17:46:44.313&patient_id=1238954367&clinician_id=135790&painter_category=A.700&media_status=END&media_date=1/192012&media_time=17:47:10.756&media_type=video&media_id=v1327013208967.mp4&media_fragment_number=4&total_fragments=4&barcode=&text_data=&checksum=26822&route=&dosage=&binary_data=xxxxxxxx

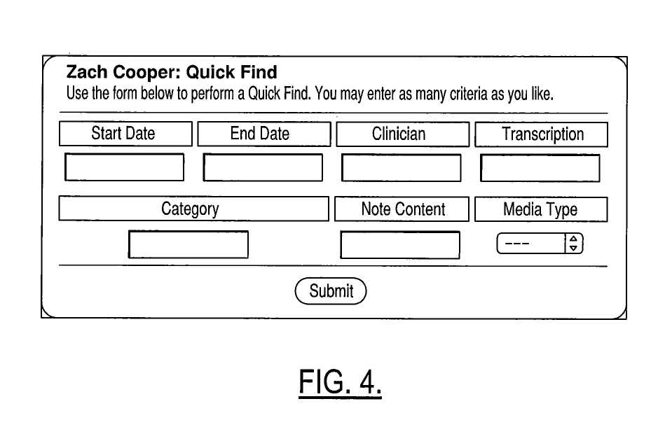

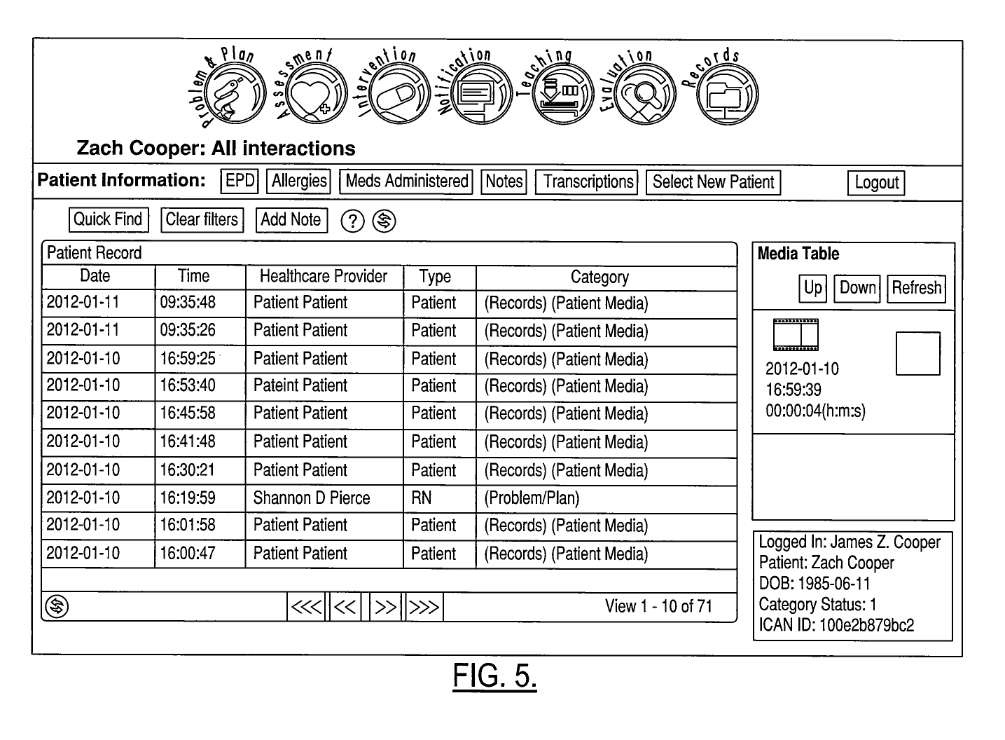

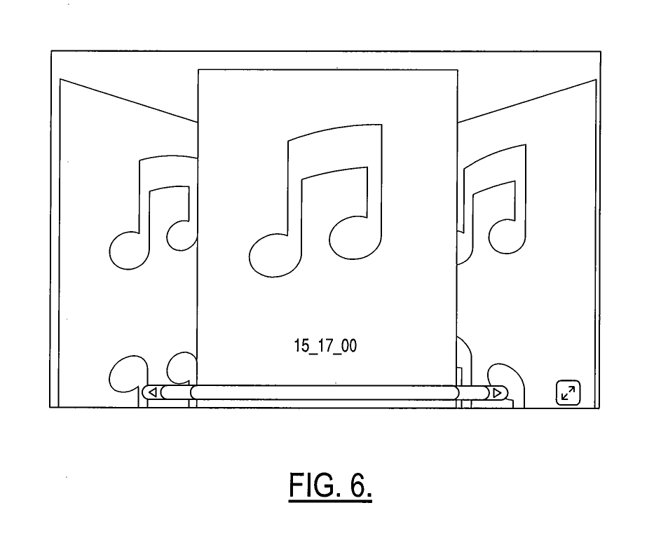

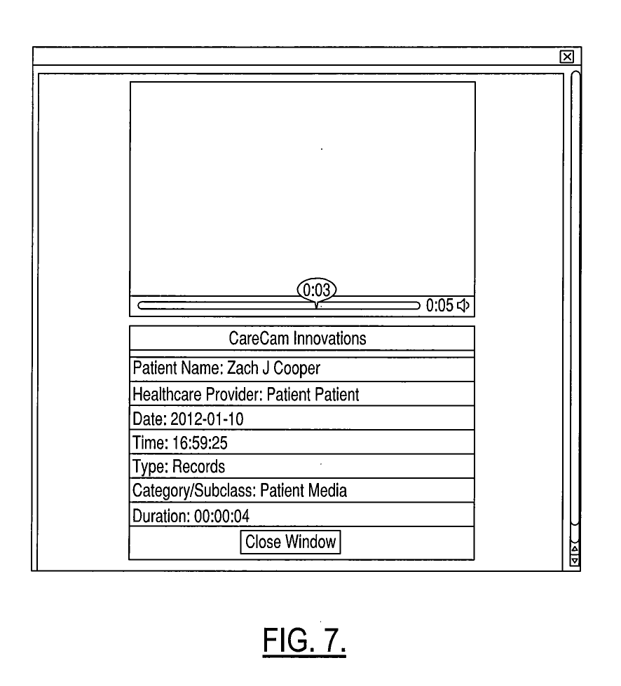

The viewer 304 may be configured to communicate with the server 302 to search or otherwise request media content and related information in any of a number of different manners. FIG. 4 is one example of a user interface that the viewer may display to enable its user or operator to perform a search of media content and its fragments, and FIG. 5 is one example of a user interface that the viewer may display to present the results of the search to the user. When the user selects an entry from the results, the appropriate fragment of media content may be retrieved by the user for presentation or consumption by the user. In one example, the fragment may be retrieved with fragments sequentially before and/or after in the same media content. FIG. 6 illustrates one view that may be presented by the viewer in which a selected fragment is presented centered about other fragments sequentially before and/or after it. And FIG. 7 illustrates one example of a view that may be presented by the viewer in presenting a selected fragment.

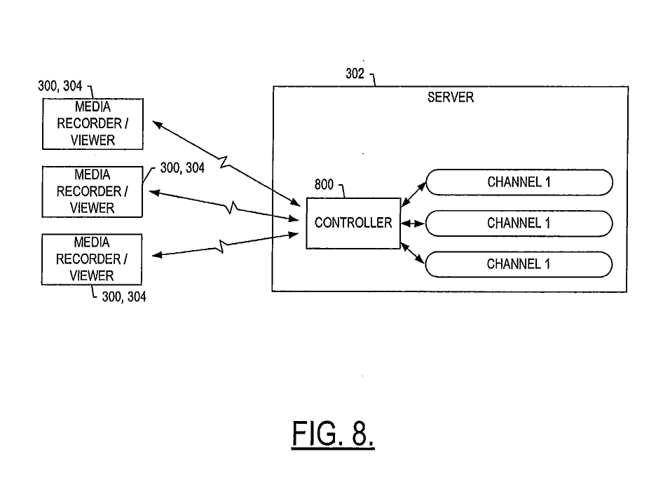

Media content and related information may be transferred between various components in any of a number of different manners, including from a media recorder/viewer 300, 304 to a server 302, and vice versa. FIG. 8 illustrates an example according to which the media recorder/viewer and server may communicate with one another. In various examples, communications and data transfer between the media recorder/viewer and server may be bi-directional. As shown in FIG. 8, the server may include a controller 800 (sometimes referred to as a smart controller), which in one example, may be part of the messaging layer of the multi-channel Iguana interface engine (an HL7 interface engine distributed by iNTERFACEWARET™ Inc.). To enable the media recorder/viewer to be available for immediate use, the controller and channel 1 must be available for immediate bi-directional communication. In one example, the channels of the interface engine may function as a first-in-first-out (FIFO) pipeline in which jobs are queued in sequential order as they are transferred to the interface engine.

As media content may be very large in file size, the interface engine's FIFO framework may create a delay in system communications between a media recorder/viewer 300, 304 and the server 302. The controller 800 of example implementations may therefore maintain channel 1 in a free state for system communications. In one example, the controller may be configured to push the large media files to channels other than channel 1. This logic may maintain channel 1 in a state for immediate communication with media recorders/viewers. Other media recorders/viewers may therefore be kept in a state of usability. As large media files are transferred from a media recorder/viewer to the interface engine in the background, the media recorders/viewers may remain in a state for additional content capture. Since multiple channels may be used for load balance of media files, this framework may provide the potential for massive scalability of media recorders/viewers.

In one example, the controller 800 may be implemented as or otherwise include a layer of code on a translation platform of the interface engine, and may delegate jobs according to logic. This logic may identify the media recorder/viewer 300, 304 differently and associate the device to a customer identifier instead of an IP address defining the translation software. This way, the controller may delegate a message to the appropriate channel configuration and populate the appropriate database based on customer configuration. In one example, the controller may be configured to intercept a message intended for the interface engine, and delegate the message to the appropriate transformation channel. The controller may interact with multiple transformation channels, such as Iguana and others (e.g., Cloverleaf, Mirth, etc.), separating out by the customer ID and configuration managed by the server 302.

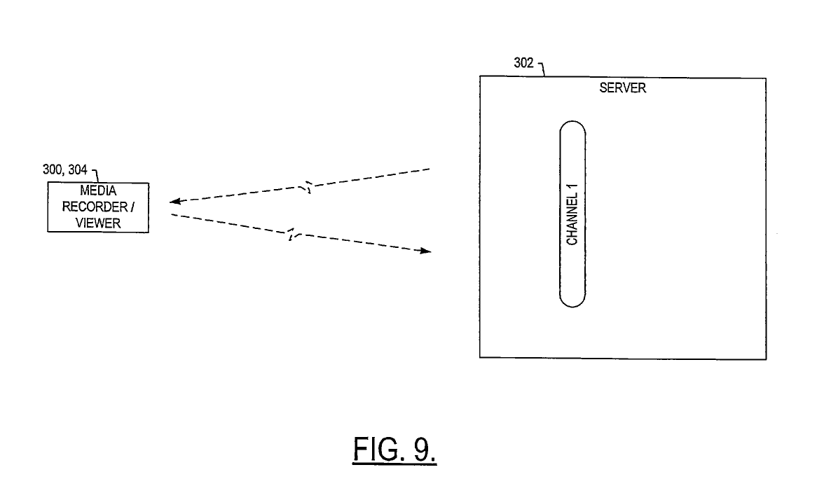

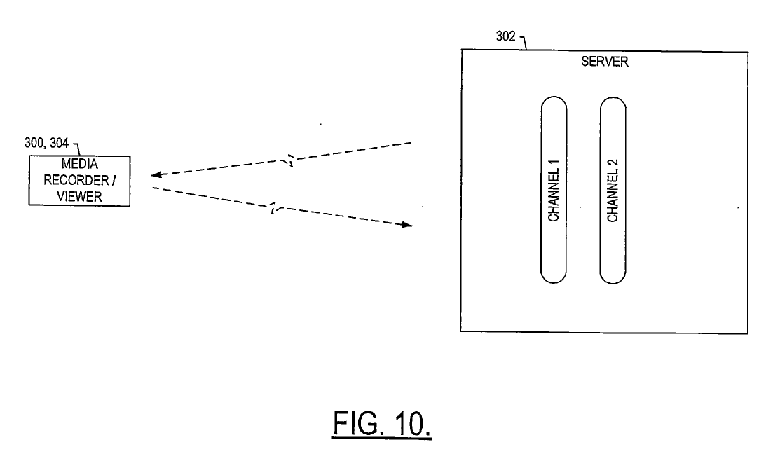

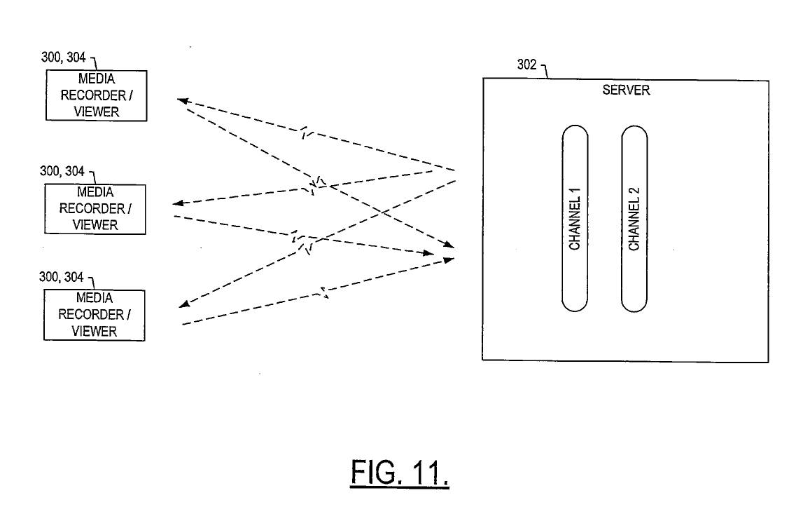

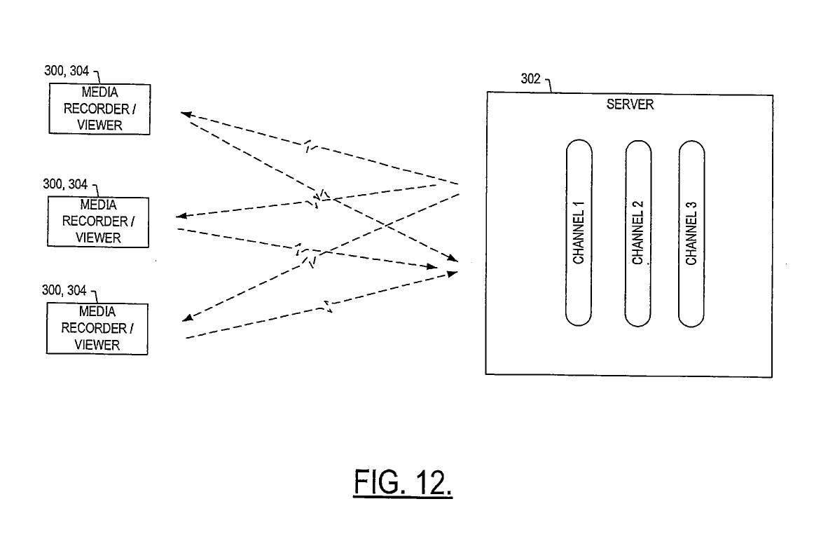

For more information on the controller aspect of example implementations, see FIGS. 9, 10, 11 and 12 in which media may be offloaded from channel 1 to another channel (e.g., channel 2, channel 3) to allow channel 1 to remain open for other communication with media recorders/viewers. The load on these other channels may be further balanced according to a multi-channel, load-balance management mechanism.

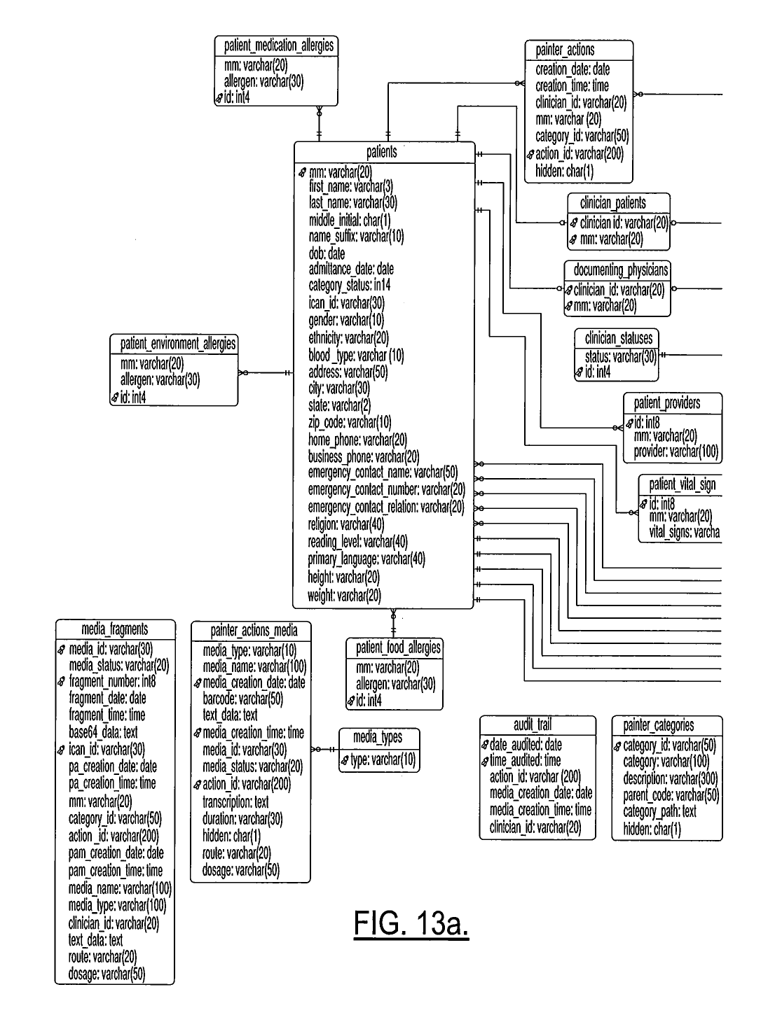

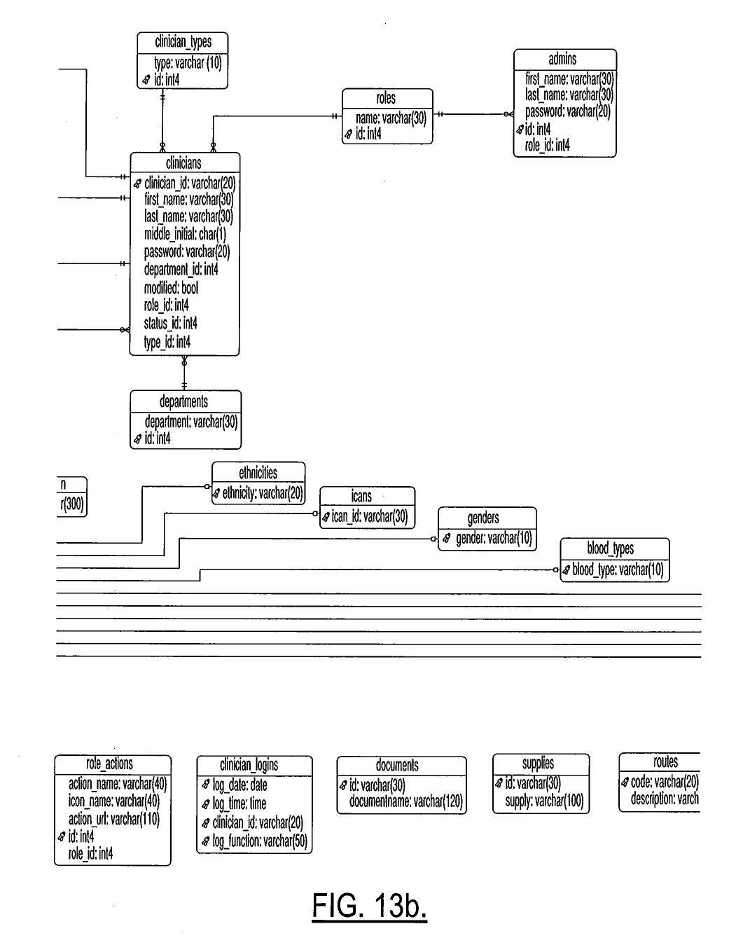

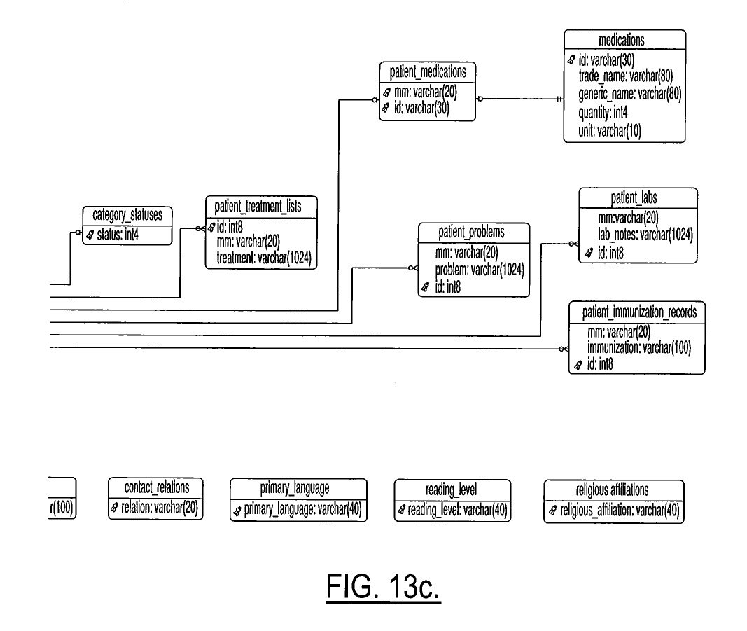

For even more information on the fragmentation, transfer from the media recorder to server, and from server to viewer 304 aspects of various example implementations, see FIGS. 13a, 13b and 13c. In various implementations, an apparatus configured to implement a media recorder 300 and/or viewer 304 may without loss of generality be referred to as an ICan; and an apparatus configured to implement a server 302 may without loss of generality be referred to as an Intelligent Work Station (IWS).

As indicated above, program code instructions may be stored in memory, and executed by a processor, to implement functions of the systems, subsystems and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, a processor or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processor or other programmable apparatus to configure the computer, processor or other programmable apparatus to execute operations to be performed on or by the computer, processor or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processor or other programmable apparatus provide operations for implementing functions described herein.

Execution of instructions by a processor, or storage of instructions in a computer-readable storage medium, supports combinations of operations for performing the specified functions. It will also be understood that one or more functions, and combinations of functions, may be implemented by special purpose hardware-based computer systems and/or processors which perform the specified functions, or combinations of special purpose hardware and program code instructions.

Many modifications and other implementations of the disclosure set forth herein will come to mind to one skilled in the art to which these disclosure pertain having the benefit of the teachings presented in the foregoing descriptions and the associated drawings. Therefore, it is to be understood that the disclosure are not to be limited to the specific implementations disclosed and that modifications and other implementations are intended to be included within the scope of the appended claims. Moreover, although the foregoing descriptions and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising a processor and a memory storing executable instructions that in response to execution by the processor cause the apparatus to at least:
communicate content between a server and media recorder or viewer, the server including a controller that is part of a messaging layer of a multi-channel interface engine having at least a first channel and a second channel each of which functions as a first-in-first-out pipeline, the communication including the apparatus being caused to:
communicate system information and media content below a threshold size over the first channel; and
push media content above the threshold size for communication over the second channel.

2. The apparatus of claim 1, wherein the multi-channel interface engine is an HL7 interface engine.

3. The apparatus of claim 1, wherein the multi-channel interface engine further has at least a third channel, and
wherein the apparatus being caused to push media content above the threshold size includes being caused to push media content above the threshold size for communication over one or more of the second or third channels according to a multi-channel load-balance management mechanism for load balancing on the second and third channels.

4. An apparatus comprising a processor and a memory storing executable instructions that in response to execution by the processor cause the apparatus to at least:
record by a media recorder, media content related to care being provided to a patient by a healthcare provider, and during the recordation:
receive selection of categories consistent with the care being provided, and
tag the media content with the selected categories; and
segment the media content along the categories into a plurality of sequential fragments, each category including one or more fragments, each fragment having associated metadata with information identifying the media recorder, patient, healthcare provider, category and an order of the fragment relative to other fragments, each fragment being independently searchable and playable, and being playable in one contiguous sequence with one or more other fragments.

5. The apparatus of claim 4, wherein the information identifying the order of the fragment relative to other fragments includes at least one of a time at which the fragment begins, or a fragment number and total number of fragments.

6. The apparatus of claim 4, wherein the apparatus is caused to receive selection of categories and tag the media content during continuous recordation of the media content.

7. The apparatus of claim 4, wherein the apparatus being caused to receive selection of categories includes being caused to:
receive voice input; and
perform voice recognition on the voice input to identify the selection of categories.

8. A method comprising a plurality of operations including at least:
communicating content between a server and media recorder or viewer, the server including a controller that is part of a messaging layer of a multi-channel interface engine having at least a first channel and a second channel each of which functions as a first-in-first-out pipeline, the communicating including:
communicating system information and media content below a threshold size over the first channel; and
pushing media content above the threshold size for communication over the second channel,
wherein the method is performed by an apparatus including a processor and a memory storing executable instructions that in response to execution by the processor cause the apparatus to perform the operations.

9. The method of claim 8, wherein the multi-channel interface engine is an HL7 interface engine.

10. The method of claim 8, wherein the multi-channel interface engine further has at least a third channel, and
wherein pushing media content above the threshold size includes pushing media content above the threshold size for communication over one or more of the second or third channels according to a multi-channel load-balance management mechanism for load balancing on the second and third channels.

11. A method comprising a plurality of operations including at least:
recording by a media recorder, media content related to care being provided to a patient by a healthcare provider, and during the recording:
receiving selection of categories consistent with the care being provided, and
tagging the media content with the selected categories; and
segmenting the media content along the categories into a plurality of sequential fragments, each category including one or more fragments, each fragment having associated metadata with information identifying the media recorder, patient, healthcare provider, category and an order of the fragment relative to other fragments, each fragment being independently searchable and playable, and being playable in one contiguous sequence with one or more other fragments,
wherein the method is performed by an apparatus including a processor and a memory storing executable instructions that in response to execution by the processor cause the apparatus to perform the operations.

12. The method of claim 11, wherein the information identifying the order of the fragment relative to other fragments includes at least one of a time at which the fragment begins, or a fragment number and total number of fragments.

13. The method of claim 11, wherein receiving selection of categories and tagging the media content occurs during continuous recording of the media content.

14. The method of claim 11, wherein receiving selection of categories includes:
receiving voice input; and
performing voice recognition on the voice input to identify the selection of categories.

15. A computer-readable storage medium having computer-readable program code portions stored therein that, in response to execution by a processor, cause an apparatus to at least:
communicate content between a server and media recorder or viewer, the server including a controller that is part of a messaging layer of a multi-channel interface engine having at least a first channel and a second channel each of which functions as a first-in-first-out pipeline, the communication including the apparatus being caused to:
communicate system information and media content below a threshold size over the first channel; and
push media content above the threshold size for communication over the second channel.

16. The computer-readable storage medium of claim 15, wherein the multi-channel interface engine is an HL7 interface engine.

17. The computer-readable storage medium of claim 15, wherein the multi-channel interface engine further has at least a third channel, and
wherein the apparatus being caused to push media content above the threshold size includes being caused to push media content above the threshold size for communication over one or more of the second or third channels according to a multi-channel load-balance management mechanism for load balancing on the second and third channels.

18. A computer-readable storage medium having computer-readable program code portions stored therein that, in response to execution by a processor, cause an apparatus to at least:
record by a media recorder, media content related to care being provided to a patient by a healthcare provider, and during the recordation:
receive selection of categories consistent with the care being provided, and
tag the media content with the selected categories; and
segment the media content along the categories into a plurality of sequential fragments, each category including one or more fragments, each fragment having associated metadata with information identifying the media recorder, patient, healthcare provider, category and an order of the fragment relative to other fragments, each fragment being independently searchable and playable, and being playable in one contiguous sequence with one or more other fragments.

19. The computer-readable storage medium of claim 18, wherein the information identifying the order of the fragment relative to other fragments includes at least one of a time at which the fragment begins, or a fragment number and total number of fragments.

20. The computer-readable storage medium of claim 18, wherein the apparatus is caused to receive selection of categories and tag the media content during continuous recordation of the media content.

21. The computer-readable storage medium of claim 18, wherein the apparatus being caused to receive selection of categories includes being caused to:
receive voice input; and
perform voice recognition on the voice input to identify the selection of categories.
